(19) United States
(12) Patent Application Publication
(10) Pub. No.: US 2011/0049350 A1
(43) Pub. Date: Mar. 3, 2011

(54) Tandem TOF Mass Spectrometer With Pulsed Accelerator To Reduce Velocity Spread

(75) Inventor: Marvin L. Vestal, Framingham, MA (US)

(73) Assignee: VIRGIN INSTRUMENTS CORPORATION, Sudbury, MA (US)

(21) Appl. No.: 12/549,076

(22) Filed: Aug. 27, 2009

(51) Int. Cl. H01J 49/40

(52) U.S. Cl. 250/282; 250/287

(57) ABSTRACT

A tandem TOF mass spectrometer includes a pulsed ion source that generates a pulse of precursor ions from a sample to be analyzed. A first pulsed ion accelerator accelerates and refocuses a predetermined group of precursor ions. A first timed ion passes the predetermined group of precursor ions and rejects substantially all other ions. An ion fragmentation chamber fragments at least some of the precursor ions in the predetermined group. A second timed ion selector selects a predetermined range of masses centered on each precursor in the predetermined group and rejects substantially all other ions. A second pulsed ion accelerator accelerates and refocuses the selected precursor ions and fragments thereof. An ion mirror generates a reflected ion beam. An ion detector detects precursor ions and fragments, wherein a flight time from the second pulsed ion accelerator to the ion detector is dependent on a mass-to-charge ratio of the selected precursor ions and fragments thereof and nearly independent of an initial velocity distribution of ions in the pulse of ions.

The section headings used herein are for organizational purposes only and should not to be construed as limiting the subject matter described in the present application in any way.

### INTRODUCTION

Many mass spectrometer applications require an accurate determination of the molecular masses and relative intensities of metabolites, peptides, and intact proteins in complex mixtures. Tandem mass spectrometry provides information on the structure and sequence of many biological polymers and allows unknown samples to be accurately identified. Tandem mass spectrometers employ a first mass analyzer to produce, separate and select a precursor ion, and a second mass analyzer to fragment the selected ions and record the fragment mass spectrum from the selected precursor. A wide variety of mass analyzers and combinations thereof for use in tandem mass spectrometry are known in the literature.

An important advantage of TOF Mass Spectrometry (MS) is that essentially all of the ions produced are detected, which is unlike scanning MS instruments. This advantage is lost in conventional MS-MS instruments where each precursor is selected sequentially and all non-selected ions are lost. This limitation can be overcome by selecting multiple precursors following each laser shot and recording fragment spectra from each can partially overcome this loss and dramatically improve speed and sample utilization without requiring the acquisition of raw spectra at a higher rate.

Several approaches to matrix assisted laser desorption/ionization (MALDI)-TOF MS-MS are described in the prior art. All of these are based on the observation that at least a portion of the ions produced in the MALDI ion source may fragment as they travel through a field-free region. Ions may be energized and fragmented as the result of excess energy acquired during the initial laser desorption process, or by energetic collisions with neutral molecules in the plume produced by the laser, or by collisions with neutral gas molecules in the field-free drift region.

These fragment ions travel through the drift region with approximately the same velocity as the precursor, but their kinetic energy is reduced in proportion to the mass of the neutral fragment that is lost. A timed-ion-selector may be placed in the drift space to transmit a small range of selected ions and to reject all others. In a TOF mass analyzer employing a reflector, the lower energy fragment ions penetrate less deeply into the reflector and, consequently, arrive at the detector earlier in time than the corresponding precursors. Conventional reflectors focus ions in time over a relatively narrow range of kinetic energies. Thus, only a small mass range of fragments are focused for given potentials applied to the reflector.

In work by Spengler and Kaufmann, the limitation in mass range was overcome by taking a series of spectra at different mirror voltages and piecing them together to produce the complete fragment spectrum. An alternate approach is to use a “curved field reflector” that focuses the ions in time over a broader energy range. A TOF-TOF approach employs a pulsed accelerator to re-accelerate a selected range of precursor ions and their fragments so that the energy spread of the fragments is sufficiently small that the complete spectrum can be adequately focused using a single set of reflector potentials. All of these approaches have been used to successfully produce MS-MS spectra following MALDI ionization, but each suffers from serious limitations that have stalled their widespread acceptance. For example, each approach involves relatively low-resolution selection of a single precursor, and generation of the MS-MS spectrum for that precursor, while ions generated from other precursors present in the sample are discarded. Furthermore, the sensitivity, speed, resolution, and mass accuracy for the first two techniques are inadequate for many applications.

### BRIEF DESCRIPTION OF THE DRAWINGS

The present teachings, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teachings in any way.

FIG. 1 shows a block diagram of a tandem TOF-TOF mass spectrometer according to the present teaching.

FIG. 2 shows a schematic diagram of a tandem TOF mass spectrometer with high resolution precursor selection and multiplexed MS-MS operation according to the present teaching.

FIG. 3 shows a schematic diagram of a tandem TOF-TOF mass spectrometer with both linear and reflecting TOF mass spectrometers.

FIG. 4 shows a potential diagram for a portion of a tandem TOF-TOF mass spectrometer according to one embodiment of the present teaching.

FIG. 5 is a schematic representation of one embodiment of a timed ion selector according to the present teaching that uses a pair of Bradbury-Nielsen type ion shutters or gates.

FIG. 6 illustrates typical voltage waveforms that are applied to the Bradbury-Nielsen timed ion selector in a TOF-TOF mass spectrometer with high resolution precursor selection and multiplexed MS-MS operation according to the present teaching.

FIG. 7 presents a graph of calculated deflection angles for the Bradbury-Nielsen timed ion selector in a mass spectrometer according to the present teaching that is capable of high resolution precursor selection.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teachings will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

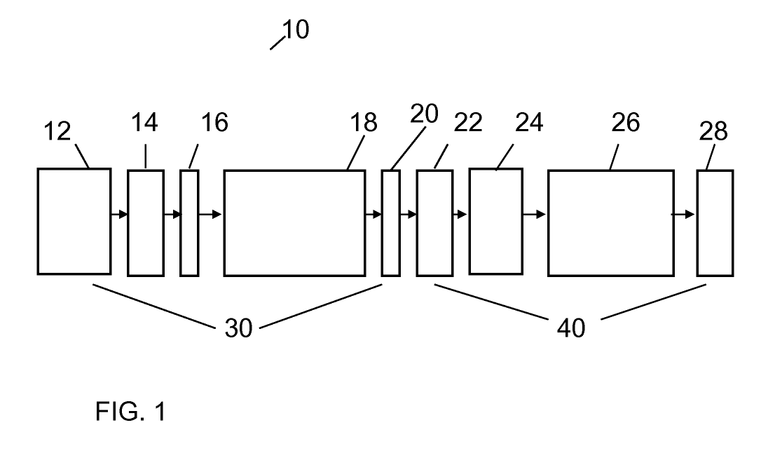

FIG. 1 shows a block diagram of a tandem TOF mass spectrometer 10 with high resolution precursor selection and multiplexed MS-MS according to the present teaching. The tandem TOF mass spectrometer 10 includes a pulsed ion source 12, a first pulsed ion accelerator 14, a first timed ion selector 16, an ion fragmentation chamber 18, a second timed ion selector 20, a second pulsed ion accelerator 22, an ion mirror 24, a field-free drift space 26, and an ion detector 28.

The pulsed ion source 12 produces a pulse of ions that is directed to the first pulsed ion accelerator 14. The first pulsed ion accelerator 14 reduces the velocity spread of ions with predetermined values of mass-to-charge ratio. The first timed ion selector 16 directs ions accelerated by first ion accelerator 14 to the ion fragmentation chamber 18 and deflects all other ions away from the fragmentation chamber 18. Ions and fragments thereof exit the ion fragmentation chamber 18 and ions with predetermined values of mass-to-charge ratio and their associated fragments are selected by the second timed ion selector 20.

Selected ions and fragments thereof are further accelerated by the second pulsed accelerator 22, reflected by the ion mirror 24, and are then directed through field-free drift space 26 to the ion detector 28. The combination of the pulsed ion source 12, the first pulsed ion accelerator 14, the ion fragmentation chamber 18, and the first 16 and second timed ion selector 20 comprise a first high resolution mass spectrometer 30 that selects and fragments multiple precursor ions following each ion pulse from pulsed ion source 12. The second pulsed accelerator 22, ion mirror 24, field-free drift space 26, and ion detector 28 comprise a second high resolution TOF mass analyzer 40 that separates fragment ions from each selected precursor ions according to the mass-to-charge ratio of the fragments and detects and records the mass spectra of the fragment ions. A unique feature of the tandem TOF mass spectrometer 10 is that mass resolving power and sensitivity of both the first 30 and the second 40 high resolution mass analyzers can be simultaneously optimized.

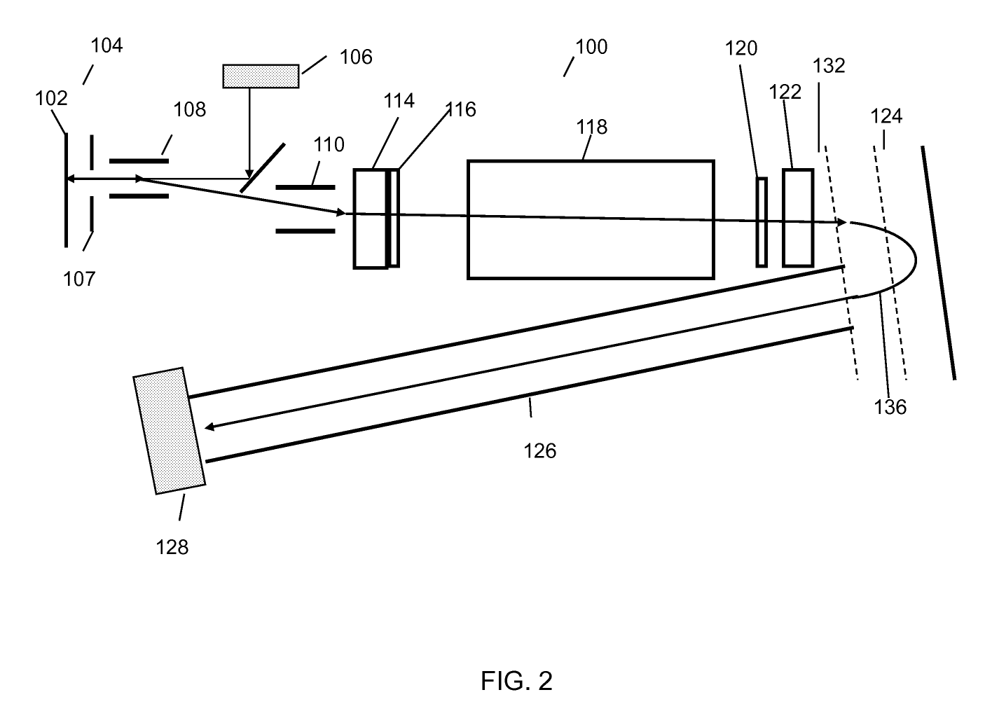

FIG. 2 shows a schematic diagram of a tandem TOF mass spectrometer 100 with high resolution precursor selection and multiplexed MS-MS operation according to the present teaching. The mass spectrometer 100 includes a sample plate 102 that is installed on a precision x-y table which allows a laser beam to raster over the sample plate at any speed. For example, the laser beam rasters over the sample plate at speeds up to about 20 mm/sec in one embodiment, but higher raster speeds are possible. The source vacuum housing (not shown), which contains the mass spectrometer 100, includes a means for quickly changing the sample plate 102 without venting the system.

The mass spectrometer 100 includes a laser desorption pulsed ion source 104. In one embodiment, the pulsed ion source 104 comprises a two-field pulsed ion source. The pulsed ion source 104 includes a laser 106 that irradiates a sample positioned on the sample plate 102 to generate ions. For example, one suitable laser 106 is a frequency tripled Nd:YLF laser operating at 5 kHz. In some embodiments, the pulsed ion source 104 comprises a matrix-assisted laser desorption/ionization (MALDI) pulsed ion source. However, it should be understood that non-MALDI pulsed ion sources and any other types of ion sources can be used with the mass spectrometer of the present teaching.

Ion source optics are positioned after the pulsed ion source 104. The ion source optics are designed for high-resolution mass spectra measurements. An extraction electrode 107 is positioned adjacent to the sample plate 102. A first pulsed ion accelerator 114 is positioned after the pulsed ion source 104 in the path of the ion beam. A first 108 and a second ion deflector 110 are positioned after ion source 104 in the path of the ion beam. The first and second ion deflectors 108, 110 deflect the ion beam to an ion fragmentation chamber 118 positioned proximate to the output of the second ion deflector 110.

In some embodiments, the first and second ion deflectors 108, 110 deflect the ion beam at a predetermined angle that reduces ion trajectory errors that limit the resolving power of the mass spectrometer. In some embodiments, the second ion deflector 110 deflects the ions at a relatively wide angle compared with known time-of-flight mass spectrometers.

In some embodiments, the pulsed ion accelerator 114 is positioned in the path of the ion beam in the space between the second ion deflector 110 and the ion fragmentation chamber 118 as depicted in FIG. 2. In other embodiments, the first pulsed ion accelerator 114 is positioned in the path of the ion beam between the first ion deflector 108 and second ion deflector 110. A first timed ion selector 116 is positioned adjacent to the first ion accelerator 114 to direct accelerated ions to the entrance of the fragmentation chamber 118 and to deflect all other ions away from the entrance of the fragmentation chamber 118. In one embodiment, the first timed ion selector 116 is positioned after the first pulsed ion accelerator 114. In other embodiments, the first timed ion selector 116 is positioned in the ion path before the first ion accelerator 114.

One skilled in the art will appreciate that any type of fragmentation chamber can be used. In one embodiment, the fragmentation chamber 118 is a collision cell containing a collision gas and an RF-excited octopole that guides fragment ions. The ion fragmentation chamber 118 fragments some of the precursor ions. Precursor ions and fragments thereof exit the fragmentation chamber 118. A differential vacuum pumping system can be included that prevents excess collision gas from significantly increasing pressure in the tandem TOF mass spectrometer.

A second timed ion selector 120 is positioned proximate to the exit of the ion fragmentation chamber 118. In one embodiment, the first and second timed ion selectors 116 and 120 are Bradbury-Nielsen type ion shutters or gates. A Bradbury-Nielsen type ion shutter or gate is an electrically activated ion gate. Bradbury-Nielsen timed ion selectors include parallel wires that are positioned orthogonal to the path of the ion beam. High-frequency voltage waveforms of opposite polarity are applied to alternate wires in the gate. The gates only pass charged particles at certain times in the waveform cycle when the voltage difference between wires is near zero. At other times, the ion beam is deflected to some angle by the potential difference established between the neighboring wires. The wires are oriented so that ions rejected by the timed ion selector 114 are deflected away from the exit aperture.

The second timed ion selector 120 passes a desired mass-to-charge ratio range of precursor ions and rejects other ions in the ion beam. The ions passed by the timed ion selector 120 enter into a second pulsed ion accelerator 122 where selected ions and their fragments are accelerated. In one embodiment, the second pulsed ion accelerator 122 further accelerates the ions and fragments thereof using a static electric field in region 132.

An ion mirror 124 is positioned after the second pulsed ion accelerator 122. An ion detector 128 is positioned after the ion mirror 124 in an electric field-free region 126. The ion mirror 124 is positioned such that ions reflected by the ion mirror 124 travel along trajectory 136 through field-free regions 126 and are focused at ion detector 128. In one embodiment, the ion detector 128 is a discrete dynode electron multiplier, such as the MagneTOF detector, which is a sub-nanosecond ion detector with high dynamic range. The MagneTOF detector is commercially available from ETP Electron Multipliers. The ion detector 128 can be coupled to a transient digitizer, which can perform signal averaging.

It should be understood by those skilled in the art that the schematic diagram shown in FIG. 2 is only a schematic representation and that various additional elements would be necessary to complete a functional mass spectrometer. For example, power supplies are required to power the pulsed ion source 104, the deflectors 108, 110, the timed ion selectors 116 and 120, the ion mirror 124, the pulsed accelerators 114 and 122, and the detector 128. In addition, a vacuum pumping arrangement is required to maintain the operating pressures in the vacuum chamber housing of the mass spectrometer 100 at the desired operating levels.

The mass spectrometer 100 provides high mass resolving power for precursor selection and for both MS and MS-MS spectra. In various embodiments, the mass spectrometer 100 can be configured for either positive or negative ions, and can be readily switched from one type of ion to the other type of ions.

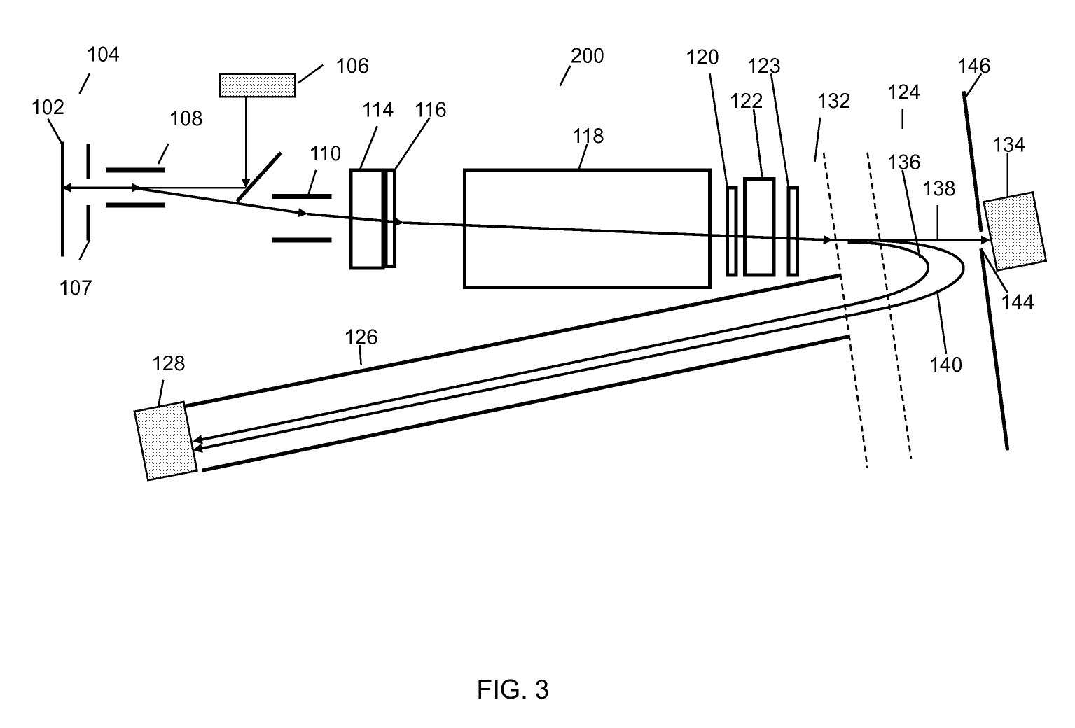

FIG. 3 shows a schematic diagram of a tandem TOF-TOF mass spectrometer 200 that includes both linear and reflecting TOF mass spectrometers. The tandem TOF-TOF mass spectrometer 200 is similar to the tandem TOF-TOF mass spectrometer 100 that was described in connection with FIG. 2. However, the tandem TOF-TOF mass spectrometer 200 includes an aperture 144 in the ion mirror 124 back plate 146 for passing ions in the linear MS mode and an ion detector 134 for detecting the ions passed in the linear MS mode.

The TOF-TOF mass spectrometer 200 can be operated in various modes. When operating the TOF-TOF mass spectrometer 200 in the linear MS mode, the timed ion selector 114, the first pulsed accelerator 116, the ion fragmentation chamber 118, the second pulsed accelerator 120, and the ion mirror 124 are all deactivated. The generated ions travel along trajectory 138 through the aperture 144 in mirror back plate 146 and are then detected by ion detector 134.

When operating the TOF-TOF mass spectrometer 200 in the reflector MS mode, the timed ion selector 114, the first pulsed accelerator 116, the ion fragmentation chamber 118, and the second pulsed accelerator 120, are all deactivated. The electrical potentials applied to the ion mirror 124 are chosen to reflect ions and fragments along trajectory 140 where they travel through a field-free region 126 and are then focused to the ion detector 128.

The ion mirror 124 generates one or more homogeneous, retarding electrostatic fields that compensate for the effects of the initial kinetic energy distribution of the ions. As the ions penetrate the ion mirror 124, with respect to the electrostatic fields, they are decelerated until the velocity component of the ions in the direction of the electric field becomes zero. Then, the ions reverse direction and are accelerated back through the ion mirror 124. The ions then exit the ion mirror 124 with energies that are identical to their incoming energy, but with velocities that are in the opposite direction. Ions with larger energies penetrate more deeply into the ion mirror 124 and, consequently, will remain in the ion mirror 124 for a longer time. In a properly designed ion mirror, the potentials are selected to modify the flight paths of the ions such that the travel time between the focal points for the ion mirror for ions of like mass and charge is independent of their initial energy.

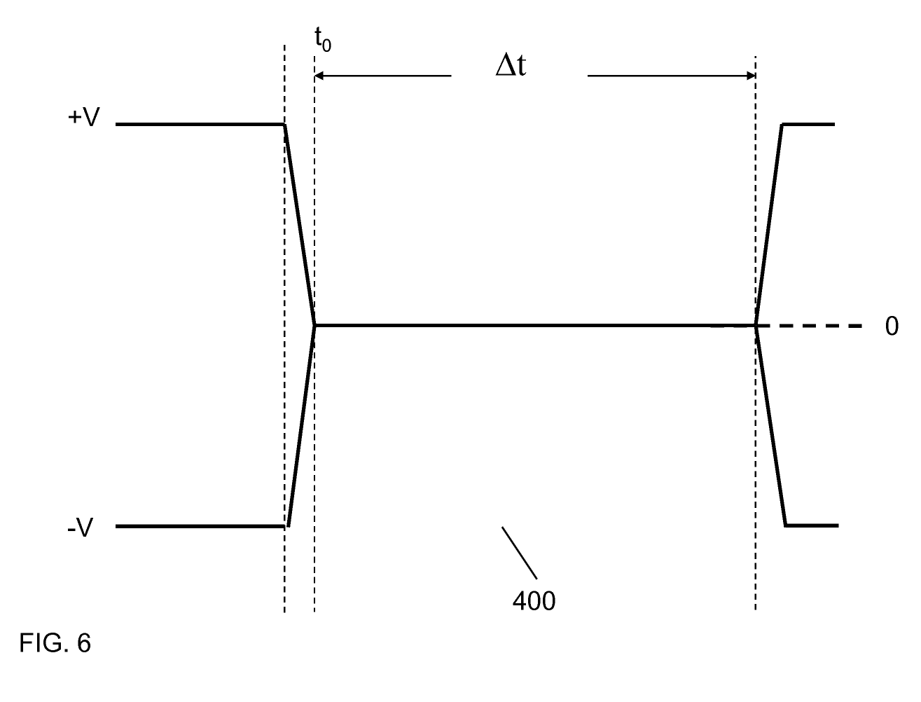

When operating the TOF-TOF mass spectrometer 200 in the MS-MS mode, the ions generated by the pulsed ion source 104 are selected by the timed ion selector 114. The selected ions are then accelerated by the first pulsed accelerator 116 into the fragmentation chamber 118 where some of the precursor ions are fragmented. Ions exiting from the fragmentation chamber 118 are further selected by the timed ion selector 120. The timed ion selectors 114, 120 are controlled by applying a pulsed voltage that causes the timed ion selectors 114, 120 to pass a portion of the ions in the ion beam and to reject other ions in the ion beam. The operation of the timed ion selectors 114, 120 is described in more detail in connection with FIGS. 6, 7, and 8.

The selected precursor ions and fragments thereof are accelerated by the pulsed ion accelerator 122. This acceleration separates fragment from precursor ions and allows fragment masses to be accurately determined from the resulting time-of-flight spectra. The precursor ions and fragments thereof are then directed to the ion mirror 124. The ion mirror 124 deflects the ions and fragment ions to trajectory 136 where they are detected by detector 128.

In one embodiment, a third timed ion selector 123 is located adjacent to the exit of the pulsed accelerator 122. In this embodiment, a portion of the fragment spectrum from each precursor ion is selected by the third timed-ion-selector 123 and transmitted to ion mirror 124 with the remaining portion of the fragment spectrum being deflected away from a second ion detector. Using this embodiment, the masses of any two precursors of the predetermined set of ions may differ by as little as one percent.

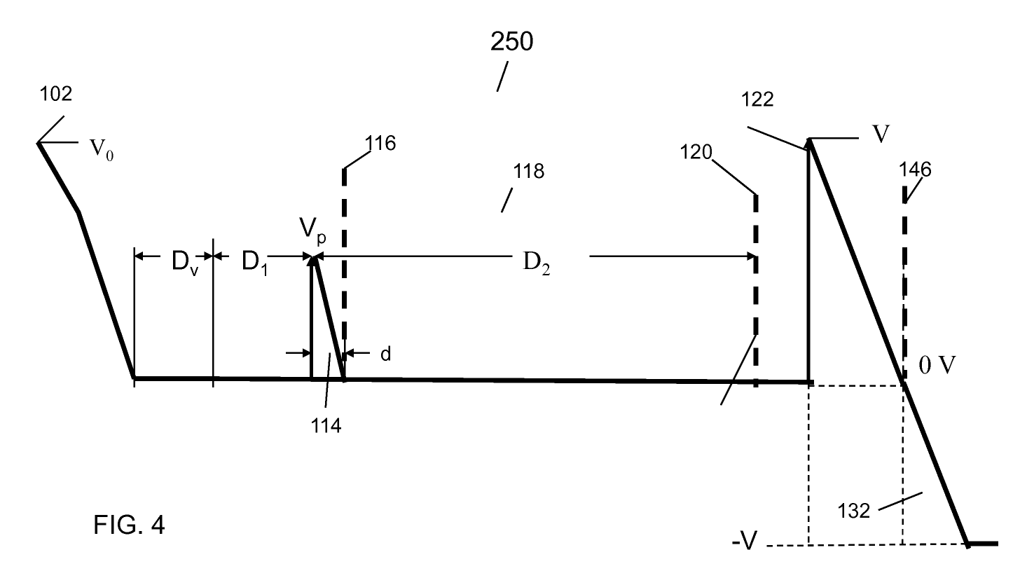

FIG. 4 shows a potential diagram 250 for a portion of the first time-of-flight mass analyzer 30 (FIG. 1) according to one embodiment of the present teaching. Referring to the TOF mass analyzer shown in FIG. 2 and to the potential diagram 250, when an ion generated by the pulsed ion source 104 substantially reaches the center of the first pulsed accelerator 114, an accelerating voltage pulse Vₚ is applied to the ion accelerator 114. If the ratio of the amplitude of the accelerating pulse Vₚ to the energy V₀ of ions exiting the mirror is equal to 4d/D₁, where d is the length of the first pulsed accelerator 114, and D₁ is the distance from the first order velocity focal point of the pulsed ion source 102 to the center of the first pulsed accelerator 114, then the velocity spread of the ions exiting the ion accelerator 114 is substantially reduced to zero and the velocity focus approaches infinity.

At relatively high pulse amplitudes, Vₚ, the velocity distribution is inverted and the velocity focus may be made to occur at any required distance. At relatively low pulse amplitudes, Vₚ, the velocity distribution is broadened. After focusing with the first pulsed accelerator, the velocity distribution is reduced by the factor (D₂/D₁)(1+4d/D₁)^{1/2}, where D₂ is the distance from the center of the first pulsed accelerator 114 to the entrance of the second timed ion selector 120. In one embodiment, the distance D₂ from the first pulsed accelerator 114 to the second timed ion selector 120 is more than 10 times the distance D₁ from the velocity focus for the pulsed ion source 102 to the first pulsed accelerator 114. Thus, a relatively broad velocity distribution at the velocity focal point for the pulsed ion source can be effectively removed, thereby allowing high performance measurements of both precursor ion and fragment mass spectra.

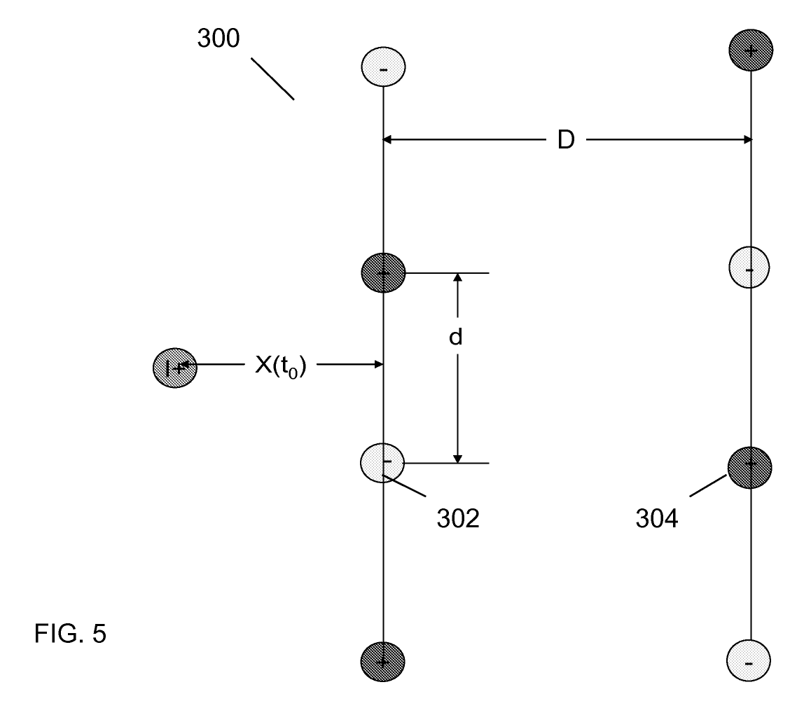

FIG. 5 is a schematic representation of one embodiment of a timed ion selector 300 according to the present teaching that uses a pair of Bradbury-Nielsen type ion shutters or gates. A Bradbury-Nielsen type ion shutter or gate is an electrically activated ion gate. Bradbury-Nielsen timed ion selectors include parallel wires that are positioned orthogonal to the path of the ion beam. High-frequency voltage waveforms of opposite polarity are applied to alternate wires in the gate. The gates only pass charged particles at certain times in the waveform cycle when the voltage difference between wires is near zero. At other times, the ion beam is deflected to some angle by the potential difference established between the neighboring wires. The wires are oriented so that ions rejected by the timed ion selectors are deflected away from the exit aperture.

The deflection of ions is proportional to the distance of the ions from the plane of the entrance aperture at the time the polarity switches. The mass resolving power can be adjusted by varying the amplitude of the voltage applied to the wires and is only weakly affected by the speed of the transition. In one specific embodiment where precise measurements are required, a power supply provides the wires of the Bradbury-Nielsen ion selector with an amplitude of approximately ±500 volts with a 7 nsec switching time.

In the embodiment depicted in FIG. 5, the timed ion selector 300 comprises two Bradbury-Nielson gates separated by a small distance D. The Bradbury-Nielson gates are formed from wires with a radius R separated by a distance d. For example, in one specific embodiment, d=1 mm, R=0.025 mm, and D=6 mm. The Bradbury-Nielson gates are closed so that ions are rejected when equal and opposite polarity voltages are applied to adjacent wires in the Bradbury-Nielson gate. The two Bradbury-Nielson gates are accurately aligned so that negatively charged wires 302 in the first gate are accurately aligned with positively charged wires 304 in the second gate.

FIG. 6 illustrates typical voltage waveforms 400 that are applied to the Bradbury-Nielsen timed ion selector in a TOF-TOF mass spectrometer with high resolution precursor selection and multiplexed MS-MS operation according to the present teaching. According to one embodiment of the present teaching, separate power supplies are used to provide the waveforms 400 for each gate. Normally one of the gates is closed and the other gate is open as a precursor ion approaches for selection. If the first gate is closed and the second gate is open as a predetermined selected mass ion approaches the gate, then the first gate is opened shortly before the ion arrives at the plane of the first gate and the second gate is closed shortly after the ion passes the plane of the second gate. In this way, lower mass ions are rejected by the first gate and high mass ions are rejected by the second gate. The Bradbury-Nielsen gates remain in this state with the first gate open and the second gate closed until the next higher predetermined mass approaches the first gate.

Shortly after the selected ion passes the plane of the first gate, the first gate is closed and the second gate is opened shortly before the selected ion reaches the second gate. In this way, lower mass ions are rejected by the second gate and higher mass ions are rejected by the first gate. Multiple mass peaks can be selected provided the arrival times differ by at least the time required for an ion to travel from the plane of the first gate to the plane of the second gate.

The equations for calculating the performance of a Bradbury-Nielsen type timed ion selector are known. Deflection angle can be determined from the following equation assuming that the voltage is turned on when the ion is at position x₀ and then turned off when the ion is at position x₁ relative to the plane of the gate:

tan α(x₀, x₁)=k(Vₚ/V₀)[(2/π)tan⁻¹({exp((πx₁/dₑ)}−(2/π)tan⁻¹{exp(πx₀/dₑ)}]

where k is a deflection constant given by k=π {2 ln[cot(πR/2d)]}⁻¹, Vₚ is the deflection voltage (+Vₚ on one wire set, −Vₚ on the other), V₀ is the accelerating voltage of the ions, and dₑ is the effective wire spacing given by dₑ=d cos[(π(d−2R)/4d], where d is the distance between wires and R is the radius of the wire. The angles are expressed in radians.

Ions approaching the Bradbury-Nielsen type timed ion selectors are traveling in the negative x direction and ions leaving the Bradbury-Nielsen type timed ion selectors are traveling in the positive x direction. For continuous application of the deflection voltage, x₀ goes to negative infinity, and x₁ goes to positive infinity. Thus, for a continuous deflection voltage, the deflection angle can be expressed by the following equation:

tan αₘₐₓ=k(Vₚ/V₀).

The deflection voltage is initially on and is turned off when an ion of interest is at distance x₁ from the plane of entrance aperture. The deflection angle is given by the following equation:

tan α=k(Vₚ/V₀))[(4/π)tan⁻¹({exp((πx₁/dₑ)}].

When the deflection voltage is turned on with the ion at position x₂, the deflection angle is given by the following equation:

tan α=k(Vₚ/V₀))[1−(2/π)tan⁻¹({exp((πx₂/dₑ)}].

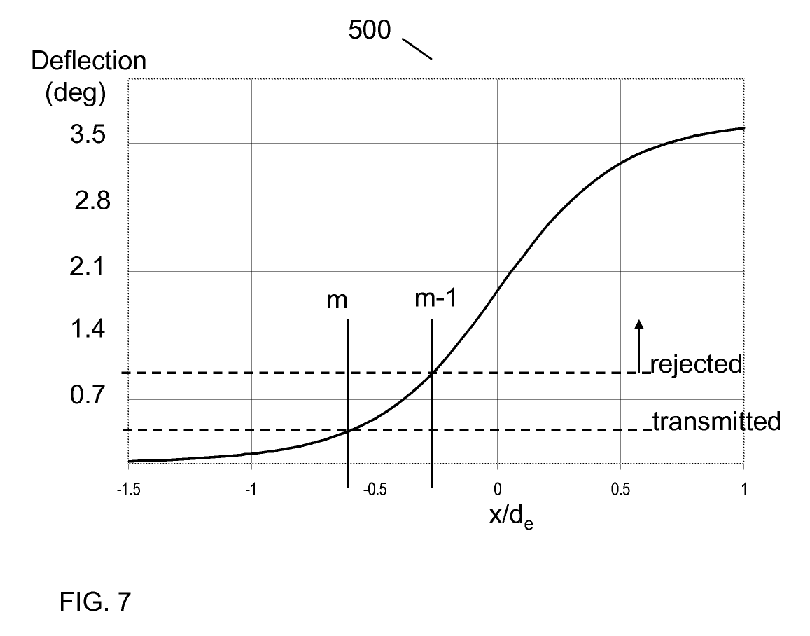

FIG. 7 presents a graph 500 of calculated deflection angles for the Bradbury-Nielsen timed ion selector in a mass spectrometer according to the present teaching that is capable of high resolution precursor selection. The deflection angles were calculated using the above equations for a mass-to-charge ratio equal to 4000. The calculations were performed for the parameters d=1 mm, R=0.025 mm, V₀=4 kV, m=4000 Da, k=0.49, d_{eff}/d=0.734, Vₚ=500 volts, and Dₑ=2000 mm.

The deflection angles in the data presented in the graph 500 of FIG. 7 are calculated as a function of mass (m/z) of the selected precursor. The deflection angles are average deflection angles in one direction. There is a corresponding second beam deflected by a similar amount in the opposite direction. The deflection angle also depends on the trajectory of the incoming ions relative to the wires in the ion selector. It is known that the total variation in deflection due to the initial y position is about ±10% of the average deflection difference.

The data shown in FIG. 7 is for calculations with m corresponding to 4000 Da. If the gate is opened when such ions are at a relative distance x/dₑ=0.6, then it is deflected through an angle of approximately 0.3 degrees. Lower mass ions are deflected through large angles. For example, m−1 (3999 Da) is located at x/dₑ=0.25 and is deflected by about 1 degree. Lower mass ions are deflected through angles up to the maximum of about 3.5 degrees as illustrated in FIG. 7. Higher mass ions are undeflected by the first gate.

The second gate is closed when the selected ion is at a relative distance x/dₑ=0.6 past the gate deflecting the ion approximately 0.3 degrees in the opposite direction from the deflection caused by the first gate. Thus, the trajectory of the selected ion is at most very slightly perturbed by the selector. The lower mass ion (m−1) is at a relative distance x/dₑ=0.95 past the plane of the gate when it is closed and its final trajectory is almost unaffected by the second gate. One the other hand, a higher mass ion (m+1) which was undeflected by the first gate is deflected by about 1 degree by the second gate.

Thus, tandem TOF mass spectrometers according to the present teaching include a MALDI ion source, a first pulsed ion accelerator for reducing the velocity spread of selected ions, a first timed ion selector for transmitting ions accelerated by the first pulsed ion accelerator and rejecting all others, an ion fragmentation chamber, a second timed ion selector for selecting predetermined precursor ions and fragments thereof, a second pulsed accelerator, an ion mirror, a field-free region, and an ion detector. Such a tandem TOF mass spectrometer provides the performance needed for high resolution selection of a large number of precursor ions for multiplex operation of the tandem TOF mass spectrometer for determining the mass-to-charge ratio spectrum of the fragment ions. The first and second ion accelerators, the ion fragmentation chamber, and the first and second timed ion selectors can be deactivated in some modes of operation and the TOF mass analyzer can provide high resolution determination of the masses generated by the pulsed ion source.

### Equivalents

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art, which may be made therein without departing from the spirit and scope of the teaching.

What is claimed is:

1. A tandem TOF mass spectrometer comprising:
a) a pulsed ion source that generates a pulse of precursor ions from a sample to be analyzed;
b) a first pulsed ion accelerator positioned to receive the pulse of precursor ions generated by the pulsed ion source, the first pulsed ion accelerator accelerating and refocusing a predetermined group of precursor ions;
c) a first timed ion selector positioned to receive the predetermined group of precursor ions accelerated by the first pulsed accelerator, the first timed ion selector passing the predetermined group of precursor ions and rejecting substantially all other ions;
d) an ion fragmentation chamber positioned to receive the predetermined group of precursor ions from the first timed ion selector, the ion fragmentation chamber fragmenting at least some of the precursor ions in the predetermined group of precursor ions;
e) a second timed ion selector positioned to receive the precursor ions and fragments thereof from the ion fragmentation chamber, the second timed ion selector selecting a predetermined range of masses centered on each precursor in the predetermined group of precursor ions and rejecting substantially all other ions;
f) a second pulsed ion accelerator that is positioned to receive selected precursor ions and fragments thereof in the predetermined range of masses from the second timed ion selector, the second pulsed ion accelerator accelerating and refocusing the selected precursor ions and fragments thereof,
g) an ion mirror having an input that is positioned in a path of the ions accelerated by the second pulsed ion accelerator, the ion mirror generating a reflected ion beam; and
h) an ion detector positioned in a path of the reflected ion beam, the ion detector detecting precursor ions and fragments, wherein a flight time from the second pulsed ion accelerator to the ion detector is dependent on a mass-to-charge ratio of the selected precursor ions and fragments thereof and nearly independent of an initial velocity distribution of ions in the pulse of ions.

2. The tandem TOF mass spectrometer of claim 1 wherein the pulsed ion source comprises a MALDI pulsed ion source.

3. The tandem TOF mass spectrometer of claim 1 further comprising an ion deflector positioned in a path of the pulse of precursor ions, the ion deflector deflecting the pulse of precursor ions at a predetermined angle to the first pulsed ion accelerator.

4. The tandem TOF mass spectrometer of claim 3 wherein the predetermined angle reduces ion trajectory errors that limit mass resolving power.

5. The tandem TOF mass spectrometer of claim 3 wherein the predetermined angle is substantially equal to a predetermined angle of the input to the ion mirror relative to a path of precursor ions and fragments.

6. The tandem TOF mass spectrometer of claim 1 further comprising:
a) a third timed ion selector positioned in a path of the precursor ions and fragments accelerated by the second pulsed ion accelerator, the third timed ion selector selecting a predetermined portion of the fragment ions from each precursor; and
b) a field-free drift space positioned between the third timed ion selector and the ion detector, the field free drift space being biased with a static accelerating field that accelerates the fragment ions and corresponding precursor ion, wherein the ion detector comprises an input surface biased at substantially the same potential as the field-free drift space.

7. The tandem TOF mass spectrometer of claim 1 wherein entrance planes of at least two of the ion mirror, the first timed ion selector, the second timed ion selector, the first ion accelerator, and the ion detector are substantially parallel.

8. The tandem TOF mass spectrometer of claim 1 wherein the timed ion selector comprises a pair of Bradbury-Nielson ion gates.

9. The tandem TOF mass spectrometer of claim 8 wherein the Bradbury-Nielson ion gates are configured to provide high resolution selection of precursor ions with reduced perturbations of transmitted ions.

10. The tandem TOF mass spectrometer of claim 1 wherein the ion mirror comprises a two-stage reflector.

11. The tandem TOF mass spectrometer of claim 1 wherein an entrance plane of the ion mirror is inclined at a predetermined angle relative to a direction of ion extraction from the pulsed ion source that is chosen to reduce ion trajectory errors which limit mass resolving power.

12. The tandem TOF mass spectrometer of claim 1 wherein the fragmentation chamber comprises a collision cell with an RF-excited octopole that guides the fragment ions.

13. The tandem TOF mass spectrometer of claim 1 wherein the ion fragmentation chamber comprises a differential vacuum pumping system that prevent excess collision gas from significantly increasing pressure in the tandem TOF mass spectrometer.

14. A method of measuring mass-to-charge ratio, the method comprising:
a) performing a first TOF mass analysis by generating an ion beam comprising a plurality of ions, accelerating the ion beam, and selecting a first group of precursor ions from the ion beam that have predetermined mass ranges;
b) fragmenting at least some of the selected first group of precursor ions;
c) selecting a second group of precursor ions and fragments; and
d) performing a second TOF mass analysis by separating the fragments and detecting a fragment ion mass spectrum from at least one of the accelerated ions.

15. The method of claim 14 wherein a mass range of the second group of precursor ions is lower than a mass range of the first group of precursor ions.

16. The method of claim 14 wherein the generating the ion beam comprises generating an ion beam from a MALDI pulsed ion source.

17. The method of claim 14 wherein the performing the first TOF mass analysis further comprises focusing the plurality of ions into an ion beam.

18. The method of claim 14 wherein the performing the first TOF mass analysis and the performing the second TOF mass analysis are independently optimized.

19. The method of claim 14 wherein the accelerating the ion beam comprises focusing the ion beam.

20. The method of claim 14 further comprising reflecting the accelerated precursor ions and fragments thereof.

21. The method of claim 20 wherein a flight time of the accelerated precursor ions and fragments is dependent on the mass-to-charge ratio of the precursor ions and fragments and is nearly independent of the velocity distribution of the second group of precursor ions.

22. The method of claim 14 further comprising selecting a predetermined portion of the fragment ions for at least one precursor ion.

23. The method of claim 14 further comprising biasing a field-free drift space with a static accelerating electric field that accelerates the fragment ions and precursors.

24. The method of claim 14 wherein the fragmenting at least some of the selected precursor ions comprises differential vacuum pumping a fragmentation chamber to prevent excess collision gas from significantly increasing pressure.

25. The method of claim 14 further comprising deflecting the ion beam at a predetermined angle that reduces ion trajectory errors which limit mass resolving power.

26. The method of claim 14 further comprising orienting the ion beam to minimize the first order focusing errors for fragment ions.

27. The method of claim 14 wherein a flight time of the accelerated second group of precursor ions is dependent on the mass-to-charge ratio of the precursor ions and is nearly independent of the velocity distribution of the selected ions.
